(19) United States
(12) Patent Application Publication
(10) Pub. No.: US 2011/0266878 A9
(43) Pub. Date: Nov. 3, 2011

(54) Transmitters and receivers for wireless energy transfer

(75) Inventors: Nigel P. Cook, El Cajon, CA (US); Stephen Dominiak, Magenwil (CH); Lukas Sieber, Olten (CH); Hanspeter Widmer, Wohlenschwill (CH)

(73) Assignee: NIGEL POWER, LLC, San Diego, CA (US)

(21) Appl. No.: 12/211,706

(22) Filed: Sep. 16, 2008

Related U.S. Application Data
(63) Continuation-in-part of application No. 12/018,069, filed on Jan. 22, 2008.
(60) Provisional application No. 60/973,100, filed on Sep. 17, 2007.
(60) Provisional application No. 60/904,628, filed on Mar. 2, 2007.

(51) Int. Cl. H02J 17/00

(52) U.S. Cl. 307/104

(57) ABSTRACT

Techniques for wireless power transmission. An antenna has a part that amplifies a flux to make the antenna have a larger effective size than its actual size.

This application claims priority from provisional application No. 60/973,100, filed Sep. 17, 2007, the entire contents of which disclosure is herewith incorporated by reference.

### BACKGROUND

It is desirable to transfer electrical energy from a source to a destination without the use of wires to guide the electromagnetic fields. A difficulty of previous attempts has been low efficiency together with an inadequate amount of delivered power.

Our previous applications and provisional applications, including, but not limited to, U.S. patent application Ser. No. 12/018,069, filed Jan. 22, 2008, entitled “Wireless Apparatus and Methods”, the entire contents of the disclosure of which is herewith incorporated by reference, describe wireless transfer of power.

The system can use transmit and receiving antennas that are preferably resonant antennas, which are substantially resonant, e.g., within 5%, 10% of resonance, 15% of resonance, or 20% of resonance. The antenna(s) are preferably of a small size to allow it to fit into a mobile, handheld device where the available space for the antenna may be limited, and the cost may be a factor. An efficient power transfer may be carried out between two antennas by storing energy in the near field of the transmitting antenna, rather than sending the energy into free space in the form of a travelling electromagnetic wave. Antennas with high quality factors can be used. Two high-Q antennas are placed such that they react similarly to a loosely coupled transformer, with one antenna inducing power into the other. The antennas preferably have Qs that are greater than 1000.

### SUMMARY

The present application describes transfer of energy from a power source to a power destination via electromagnetic field coupling. Embodiments describe techniques for maximizing the energy transfer.

### BRIEF DESCRIPTION OF THE DRAWINGS

These and other aspects will now be described in detail with reference to the accompanying drawings, wherein:

FIG. 1 shows a basic block diagram of a wireless power systems;

FIGS. 2A and 2B show block diagram showing distance limit of non-radiative wireless transfers;

FIG. 3 shows wireless transfer using resonant coil antenna;

FIGS. 4A and 4B show equivalent circuit at resonance frequency showing lost parts;

FIG. 4C shows an equivalent circuit of mutual inductance FIGS. 5A-5C show different solenoid geometries;

FIG. 6 shows a rectangular resonance loop;

FIGS. 7A and 7B show a cute factor operation;

FIG. 8 shows a coupling loop;

FIG. 9 shows a graph of power transfer versus distance;

FIGS. 10 A. and 10 B. shows the effect of a lossy environment on high resonators;

FIGS. 11 A.-11 C. show the differences between high inductance to capacitance ratio resonant circuits and low inductance to capacitance ratio resonant circuit; the line FIGS. 12 A.-12 C. illustrate the integration of wireless power into a portable device;

FIGS. 13 A.-13 B. shows the different ways that antennas can be integrated into the package of such a device;

FIG. 14 shows the magnetic field and dipole moment's within a ferrite Rod;

FIG. 15 illustrates flux concentrating effect of a ferrite Rod;

FIG. 16 shows how to exploit the Gyro magnetic affect of ferrite antennas;

FIG. 17 illustrates the basic principle of a torsion type magneto mechanical systems; and

FIG. 18 illustrates how to use a magneto restrictive and piezoelectric device in order to generate electrical power from a low magnetic field.

### DETAILED DESCRIPTION

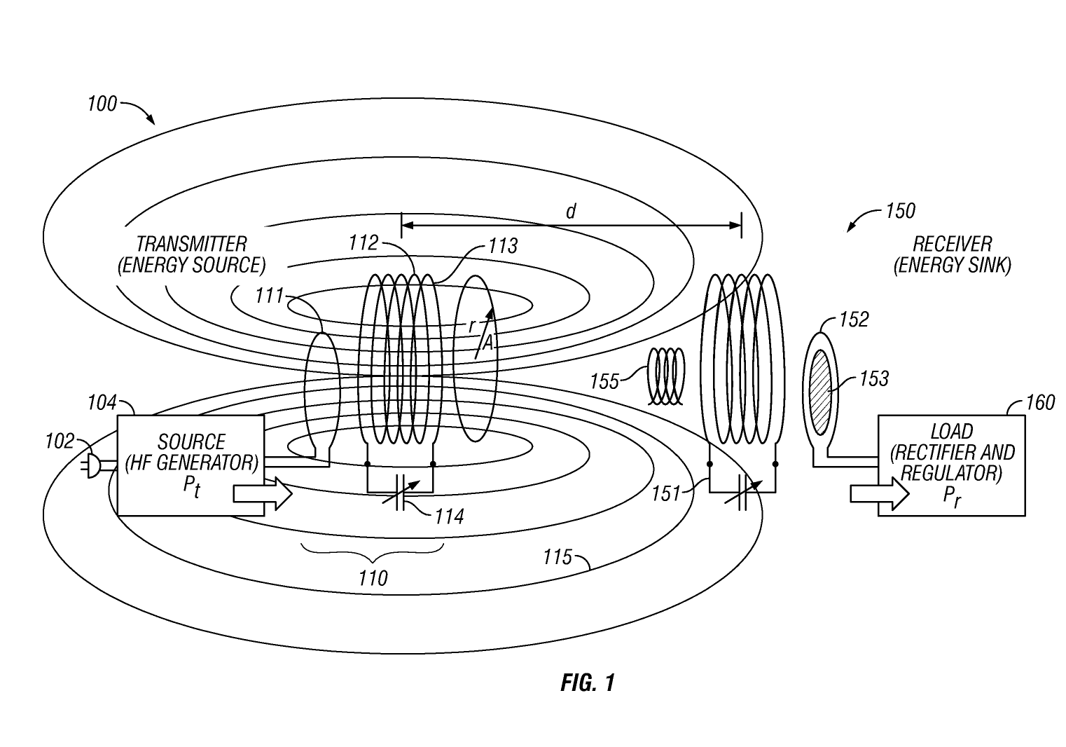

A basic embodiment is shown in FIG. 1. A power transmitter assembly 100 receives power from a source, for example, an AC plug 102. A frequency generator 104 is used to couple the energy to an antenna 110, here a resonant antenna. The antenna 110 includes an inductive loop 111, which is inductively coupled to a high Q resonant antenna part 112. The resonant antenna includes a number N of coil loops 113 each loop having a radius R_{A}. A capacitor 114, here shown as a variable capacitor, is in series with the coil 113, forming a resonant loop. In the embodiment, the capacitor is a totally separate structure from the coil, but in certain embodiments, the self capacitance of the wire forming the coil can form the capacitance 114.

The frequency generator 104 can be preferably tuned to the antenna 110, and also selected for FCC compliance.

This embodiment uses a multidirectional antenna 115 shows the energy as output in all directions. The antenna 100 is non-radiative, in the sense that much of the output of the antenna is not electromagnetic radiating energy, but is rather a magnetic field which is more stationary. Of course, part of the output from the antenna will in fact radiate.

Another embodiment may use a radiative antenna.

A receiver 150 includes a receiving antenna 155 placed a distance D away from the transmitting antenna 110. The receiving antenna is similarly a high Q resonant coil antenna 151 having a coil part and capacitor, coupled to an inductive coupling loop 152. The output of the coupling loop 152 is rectified in a rectifier 160, and applied to a load. That load can be any type of load, for example a resistive load such as a light bulb, or an electronic device load such as an electrical appliance, a computer, a rechargeable battery, a music player or an automobile.

The energy can be transferred through either electrical field coupling or magnetic field coupling, although magnetic field coupling is predominantly described herein as an embodiment.

Electrical field coupling provides an inductively loaded electrical dipole that is an open capacitor or dielectric disk. Extraneous objects may provide a relatively strong influence on electric field coupling. Magnetic field coupling may be preferred, since extraneous objects in a magnetic field have the same magnetic properties as “empty” space.

The embodiment describes a magnetic field coupling using a capacitively loaded magnetic dipole. Such a dipole is formed of a wire loop forming at least one loop or turn of a coil, in series with a capacitor that electrically loads the antenna into a resonant state.

Wireless energy transfer, however, requires an analysis of the efficiency. The efficiency data can be expressed as

$$η = \frac{{P}_{r}}{{P}_{t}}$$

where Pr is power output at the receive antenna and Pt is power input at the transmit antenna.

The inventors considered both electrical field coupling and magnetic field coupling, and have decided that magnetic field coupling may be more promising for wireless power transfer. While electrical field coupling may be promising for proximity power transmission, a significant problem from electrical field coupling is that it shows a relatively strong influence from extraneous objects. Electrical field coupling uses an inductively loaded electrical dipole e.g. an open capacitor or dielectric disc.

Magnetic field coupling, as used according to embodiments, uses a capacitively loaded magnetic dipole antenna as described in the embodiments. This antenna can include a conductive single loop or series of loops with a capacitor attached across the inductance. Magnetic field coupling may have the advantage of relatively weak influence from extraneous objects.

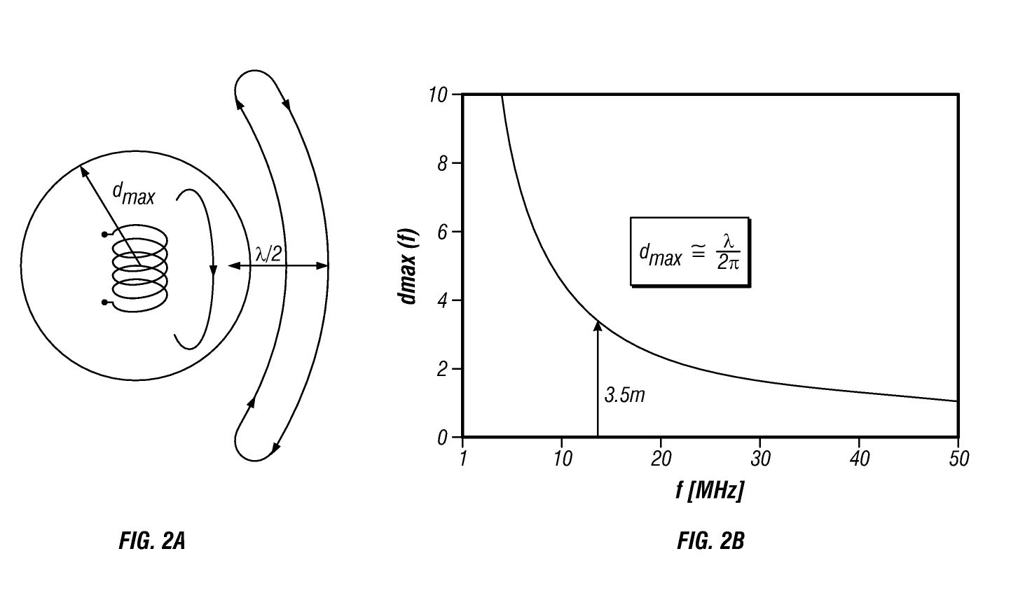

FIGS. 2A and 2B illustrate representative “near field” conditions for non-radiative energy transfer. The distance between a coil that is transmitting the information, and the receiver of the information is plotted in FIG. 2B for the arrangement shown in FIG. 2A. Of course, this energy transfer characteristic is highly dependent on different parameters, including the frequency that is used and the characteristics of the antenna and receiver. However, for a specified set of characteristics shown in FIGS. 2A and 2B, a distance curve shown in FIG. 2B can be obtained, showing a reasonable amount of energy transfer at 3½ m.

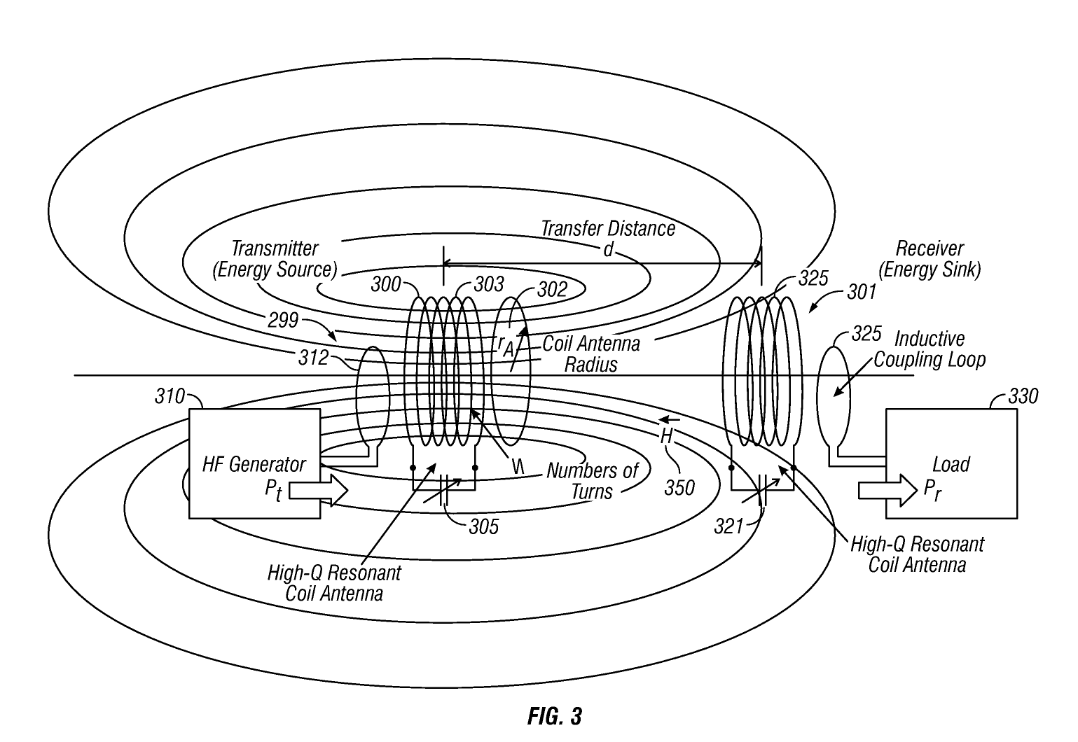

A desirable feature of this technique is to use resonant coil antennas, with an inductance coil 300 in the series with a capacitance 305. FIG. 3 illustrates a receiver 301 receiving power from the transmitter that has been wirelessly transmitted using a magnetic field and resonant coil antennas. The transmitter 299 includes a high frequency generator 310 which generates a power Pₜ into a coupling loop 312. The coupling loop couples this power to a main antenna 300. The main antenna 300 has a coil radius 302 of R_{A}, and a number of turns N. The antenna includes a coil portion 303 in series with a capacitance 305. The LC value of the coil and capacitance are tuned to be resonant to the driving frequency, here 13.56 MHz preferably. This creates a magnetic field H shown as 350.

A receiving coil 320 has a capacitance 321 connected in series therewith, in the area of the magnetic field, located a transfer distance d away from the transmit antenna. The received energy from the receiving antenna 320, 321 is coupled to coupling loop 325, and sent to a load 330. The load may include, for example, power rectification circuitry therein.

The loss resistance within the circuit is dependent on radiation resistance, eddy current losses, skin and proximity effect, and dielectric losses.

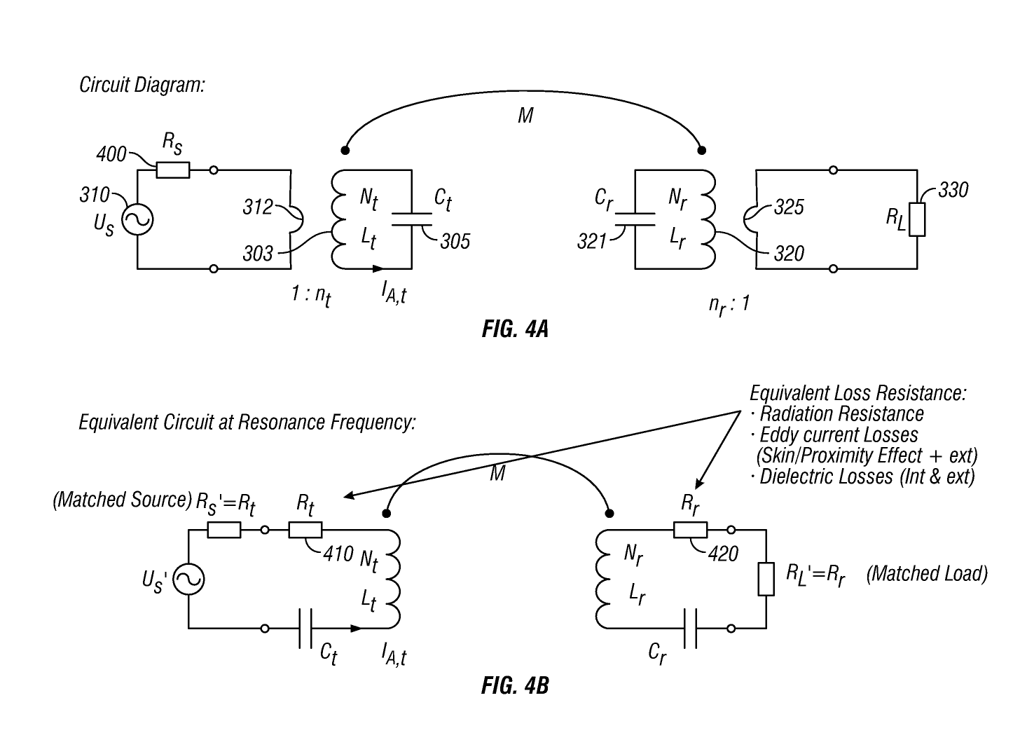

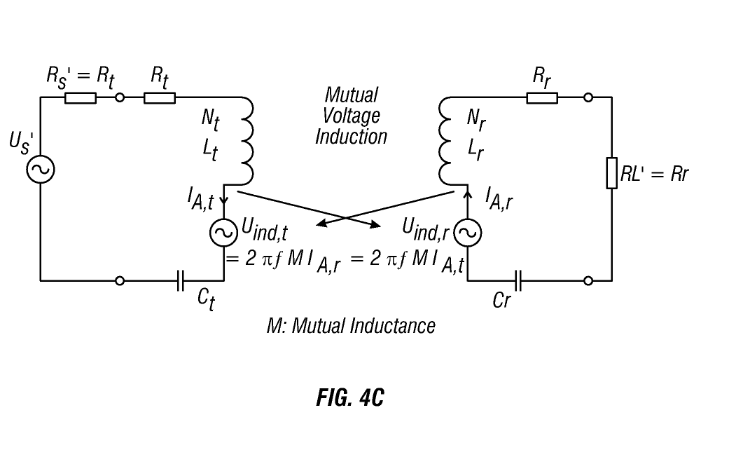

FIGS. 4A and 4B illustrate equivalent circuit diagrams, and the loss circuits equivalent to these diagrams. The equivalent circuit in FIG. 4A shows equivalent circuits to those discussed in FIG. 3A, including an equivalent diagram of the HF generator 310, coupling coil 312, main coil 303, capacitance 305, as well as receive capacitance 321, received coil 320, received coupling coil 325, and load 330. FIG. 4A also shows, however, a equivalent loss resistance Rₛ 400, as well as eddy current losses and others. FIG. 4B illustrates the radiation resistance 410, the eddy current losses 420, and other effects.

FIG. 4C shows how an equivalent circuit of mutual inductance can be formed, were the mutual voltage inductance is can be offset against one another. For example, the current flows in the two sources can be made equivalent to one another according to their mutual inductance.

The transfer efficiency can be derived according to the equations:

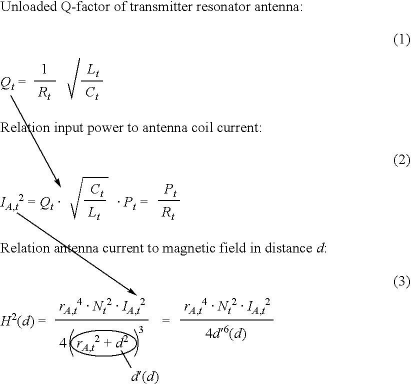

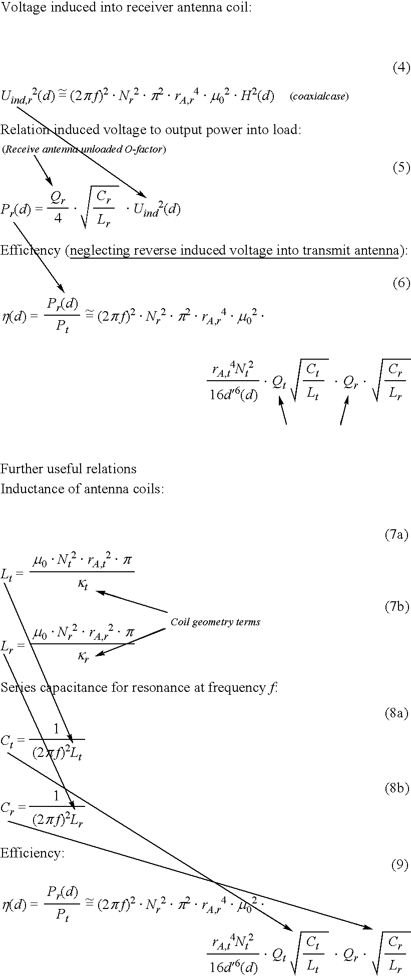

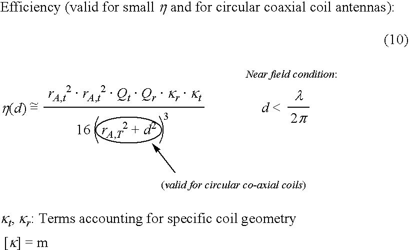

Three specific coil geometry forms are shown in FIGS. 5A-5C.

FIG. 5A shows an air solenoid, where the total thickness of the solenoid is of value I_{A}. FIG. 5B shows a loop, where the parts of the coil-wound parts are very close together. In this loop, the value I is much less than the radius r_{A}. Finally, FIG. 5C shows a ferrite rod antenna embodiment.

The coil characteristics are as follows:

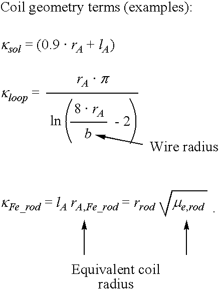

The transfer efficiency can therefore be calculated as

$$\begin{matrix}Near field condition \text{:} & \\ η ( d ) ≅ \frac{{r}_{A , t}^{3} \cdot {r}_{A , r}^{3} \cdot {Q}_{t} \cdot {Q}_{r}}{16 {d}^{6}} for d ≅ {d}^{′} \\ d < \frac{λ}{2 π} & ( 14 )\end{matrix}$$

So, given a Q-factor, efficiency is no longer a function of frequency.

Efficiency decreases with d⁶.

Doubling transmitter coil radius increases range by sqrt (2)=(41%)

Doubling transmitter Q-factor doubles efficiency

Doubling Q-factor increases distance only by sixth root of 2(12%).

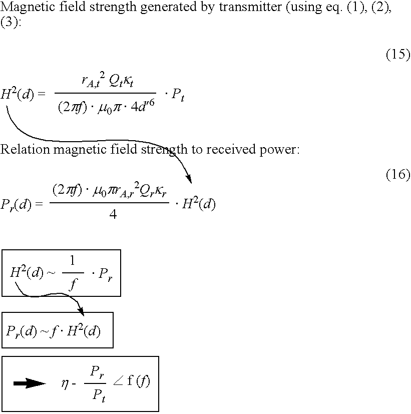

Conclusion:
[symbol] To transfer the same amount of power, the generated H-field strength increases proportionally to \sqrt{1/f} with decreasing frequency
[symbol] E.g. at 135 kHz 20 dB higher H-field strength is generated than at 13.5 Mhz

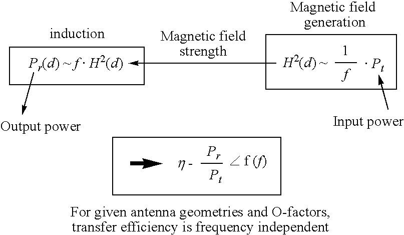

### Conclusion:

[symbol] To transfer the same amount of power, the generated H-field strength increases proportionally to with decreasing frequency
[symbol] E.g. at 135 kHz a 20 dB higher H-field strength is generated than at 13.5 MHz

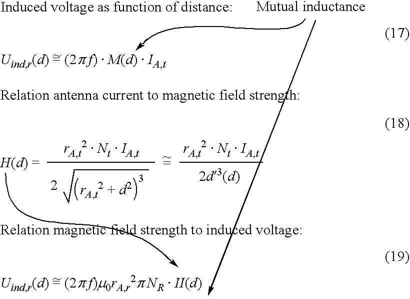

$$\begin{matrix}Mutual inductance \text{:} & \\ M ( d ) ≅ \frac{{μ}_{0} π {r}_{A , t}^{2} {r}_{A , r}^{2} {N}_{R} {N}_{t}}{2 {d}^{′ 3} ( d )} & ( 20 )\end{matrix}$$

$$\begin{matrix}Coupling factor ( definition ) \text{:} & \\ k ( d ) ≅ \frac{M ( d )}{\sqrt{{L}_{t} \cdot {L}_{R}}} & ( 21 )\end{matrix}$$

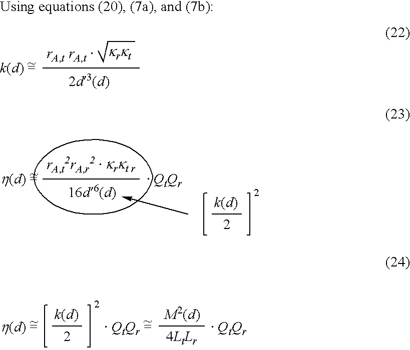

$$\begin{matrix}Definition of mutual quality factor \text{:} & \\ {Q}_{tr} ( d ) ≅ \frac{( 2 π f ) \cdot M ( d )}{\sqrt{{R}_{t} {R}_{t}}} & ( 25 ) \\ & ( 26 ) \\ η ( d ) ≅ \frac{1}{4} {Q}_{tr}^{2} ( d ) & ( 26 )\end{matrix}$$

Based on these characteristics, the coupling factor can be considered primarily a function of geometric parameters and distance. The distance cannot be controlled, but of course the geometric parameters can be. The mutual inductance, overall loss resistances of the antennas and operating frequencies may also relate to the efficiency. Lower frequencies may require lower loss resistances or higher mutual inductance to get the same transfer efficiency as at higher frequencies.

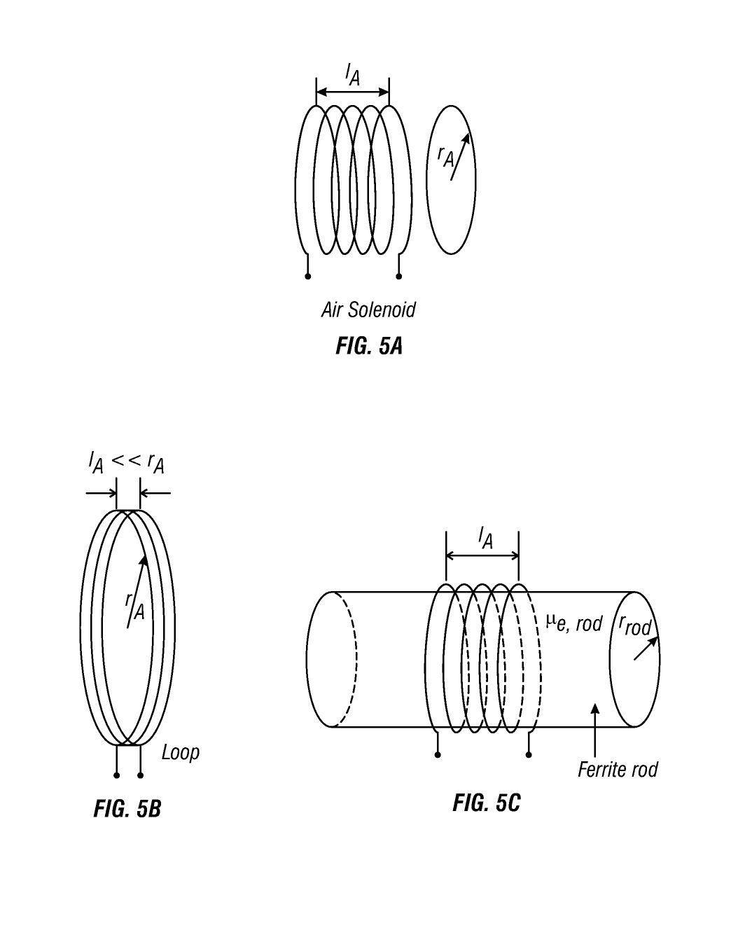

The transfer efficiency for a rectangular loop is as follows, for the loop with characteristics shown in FIG. 6.

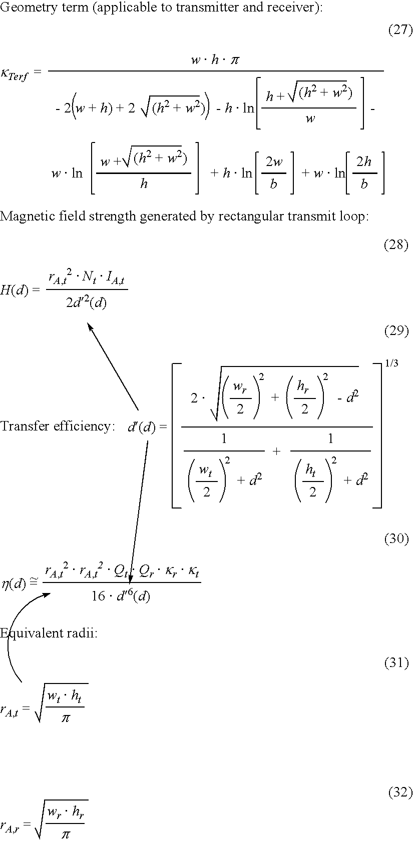

Optimization of the number of turns can be considered as follows:

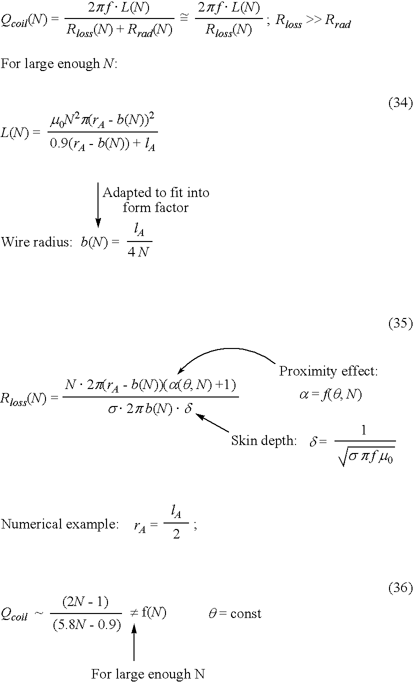

for a coil of length lA, radius rA, and pitch to wire diameter ratio of θ=2c/2b.

If resonance frequency is used as the optimization parameter, then

$$\begin{matrix}{Q}_{coil} ( f ) = \frac{2 π f \cdot L}{{R}_{loss} ( f ) + {R}_{rad} ( f )} ; ( Inductance is kept constant ) & ( 37 ) \\ {R}_{loss} ( f ) - \sqrt{f} ( skin effect ) & ( 38 ) \\ {R}_{rad} ( f ) = 320 {{π}^{4} ( \frac{π {r}_{A}^{2}}{{λ}^{2}} )}^{2} {N}^{2} \sim {f}^{4} & ( 39 ) \\ At low frequency ( Skin effect predominant ) \text{:} & \\ {Q}_{coil} \sim \sqrt{f} & ( 40 ) \\ At high frequency ( Radiation resistance predominant ) \text{:} & \\ {Q}_{coil} \sim \frac{\sqrt{f}}{{f}^{2}} & ( 41 )\end{matrix}$$

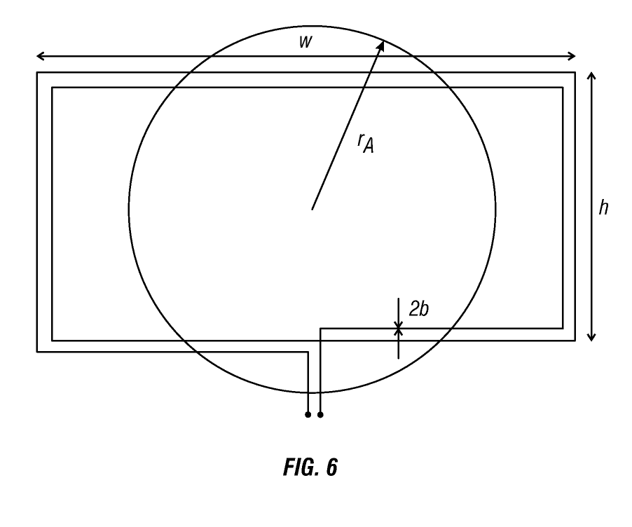

FIGS. 7A and 7B show some specific numerical examples. for coil radius ra 8.5 cm; coil length la of 8 cm, wire diameter of 6 mm, number of turns N of 8, and wire conductiviety of copper 58×10⁶ FIG. 7A shows the capacitance needed for resonance 700, and shows the self capacitance bound 705. FIG. 7B shows the Q factor 720 at 13.56 Mhz; again showing the self capacitance bound 725.

From these equations, we can draw the conclusion that for given coil form factor the Q factor is independent to some extent of the number of turns. Coils formed of thicker wires and less windings may perform as well as coils with a higher number of turns. However, the Q factor is highly dependent on the frequency. At low frequencies the Q factor increases according to f^{1/2}. This is dependent primarily on the skin effect. At higher frequencies, the key factor increases as f^{-7/2}. This is dependent on the skin effect plus the radiation resistance.

There exists an optimum frequency where the Q is maximized. For any given coil this depends on the coil's form factor. The maximum Q, however, almost always occurs above the self resonance for frequency of the coil. Near self resonance, the coil resonator is extremely sensitive to its surroundings.

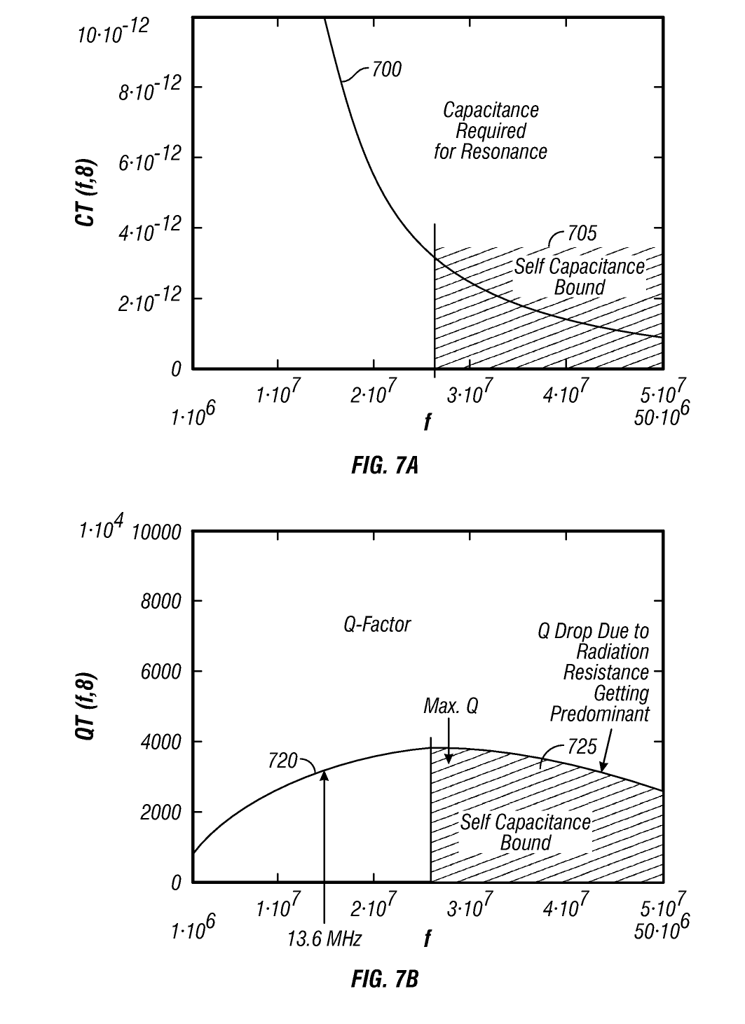

FIG. 8 illustrates an experiment conducted to find values which maximize the results. This uses a coil with the following characteristics
Coil characterstics:
Radius: r_{A,t}=r_{A,r}=8.5 cm
Length: l_{A,t}=l_{A,r}=20 cm
Wire diameter: 2b_{A,t}=2b_{A,r}=6 mm
Number of turns: Nₜ=Nᵣ=7
Coil material: Silver plated copper
Theoretical Q-factors: Qₜₕₑₒᵣ≅2780
Measured Q-factors: Qₘₑₐₛ≅1300

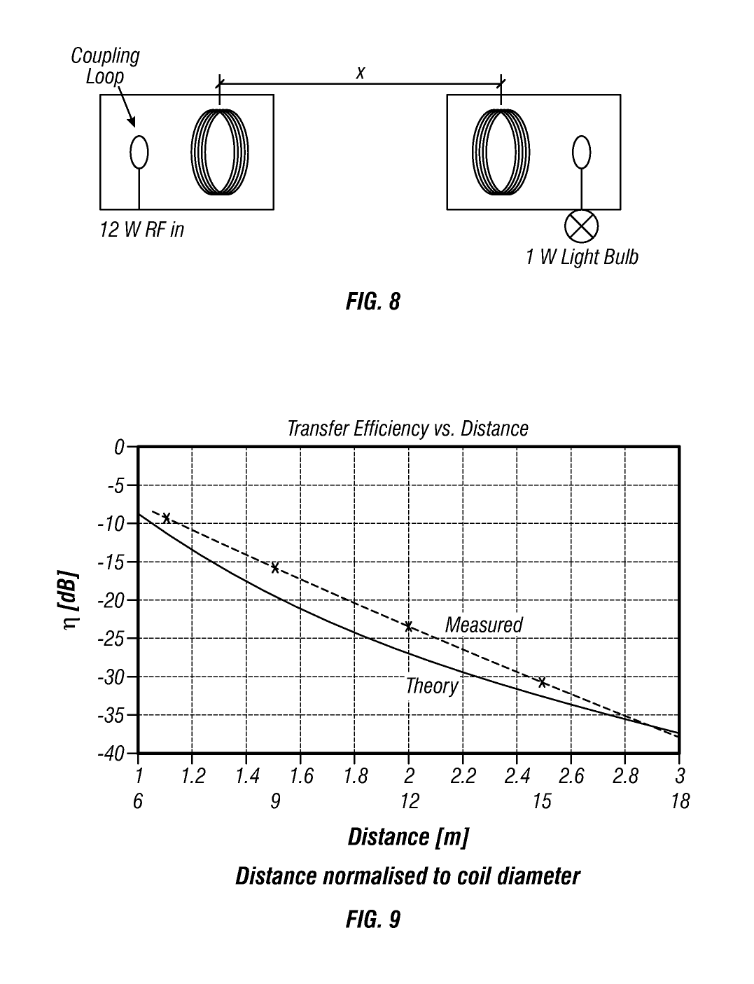

This produced a result shown in FIG. 9, over distance, showing an efficiency slightly higher than calculated.

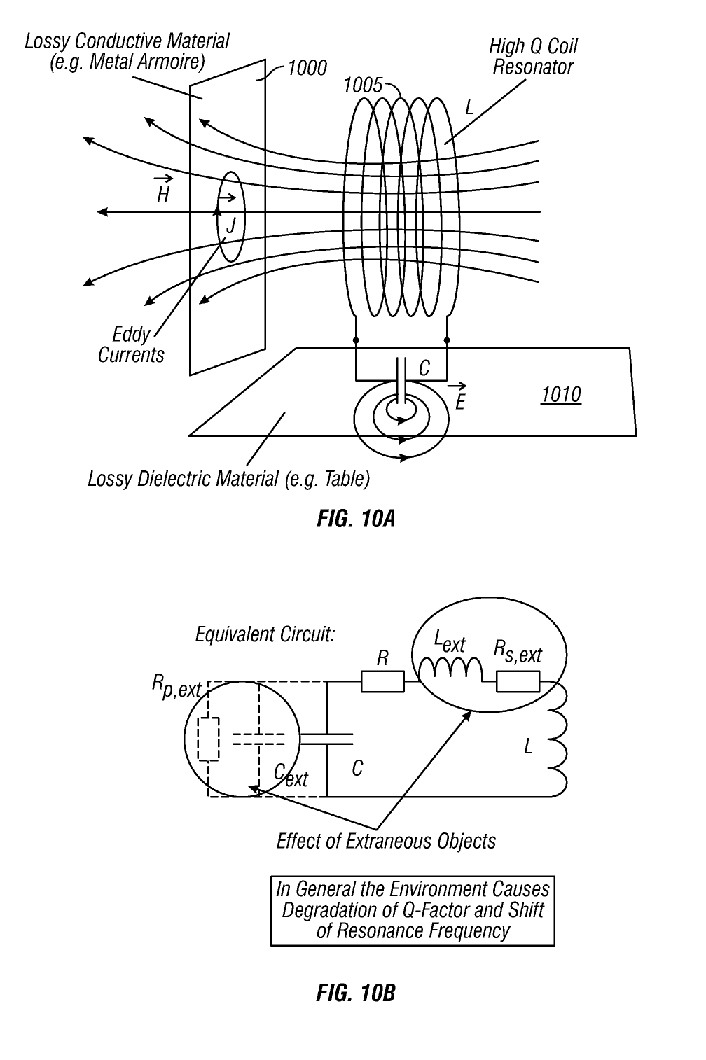

The magnetic power transmission according to this disclosure may rely on high-Q for improved efficiency. A lossy environment can have a deleterious effect on high Q resonators. Using the antenna 1005 near a lossy material such as a dielectric material 1010 such as a table or a conductive material such as a metal part 1000 is shown in FIG. 1A. The extra parts create extraneous objects which can be which are shown as modeled in the equivalent circuit of FIG. 10B. In general, these will change the self resonance frequency and shift or degrade the Q factor unless compensated. In one embodiment, a tuning element such as the any of the different tuning elements described herein, may also be included which can compensate the effect of the extraneous objects on Q of the antenna.

In order to reducing the effects of the environment, various measures can be taken. First, consider the Q factor

$$Q \text{-} factor \text{:}$$

$$Q = \frac{1}{R} \sqrt{\frac{L}{C}}$$

$$Resonance frequency \text{:}$$

$${f}_{res} = \frac{1}{2 π \sqrt{LC}}$$

This is three variables and two equations, leaving 1 degree of freedom for the resonator design.

Resonators with low inductance to capacitance ratios tend to be more stable in an environment where dielectric losses are predominant. Conversely, high inductance to capacitance ratio resonators tend to be more stable in environments where eddy current losses are predominant. Most of the time, the dielectric losses are predominant, and hence most of the time it is good to have a low L/C ratio.

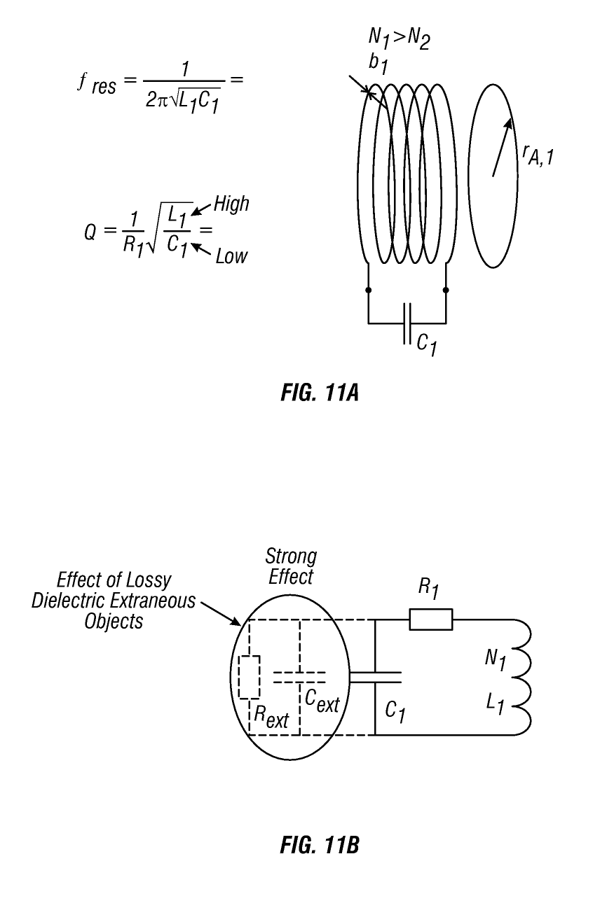

FIG. 11A shows a resonator whose equivalent circuit for a high L/C ratio resonant circuit is shown in FIG. 11B. This resonator can be described as:

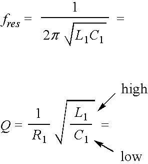

Note that there is a strong effect from lossy dielectrics.

FIG. 11C shows a loop resonator with a low number of turns, hence low L/C ratio. FIG. 11D shows that there is a reduced effect from the dielectric.

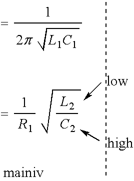

Exemplary resonators for environments with lossy dielectrics can include 13.56 MHz plus coupling loop may using a seven turn, 6 mm silver plated copper wire with a 17 cm coil diameter and an air capacitor of 10 pF. Conversely, a low L/C ratio resonator for this frequency can operate without a coupling loop, using a 3 cm silver plated copper tube, 40 cm diameter loop and high-voltage vacuum capacitor of 200 pf.

For the low L/C resonant antennas, a vacuum capacitor may produce significant advantages. These might be available in capacitance value of the several nanofarads, and provide Q values greater than 5000 with very low series resistance. Moreover, these capacitors can sustain RF voltages up to several kilovolts and RF currents up to 100 A.

To conclude from the above, high L/C ratio resonator antennas e.g. multi-turn loops are more sensitive to lossy dielectrics. Low L/C ratio resonator antennas e.g. single turn loops are more sensitive to a lossy conductive or ferromagnetic environment. Q factors of the described antennas, however, may vary between 1500-2600. A single turn transmit loop of 40 cm in diameter may have a Q value larger than 2000.

The wireless power may be integrated into portable devices and a number of different ways as shown in FIGS. 12A-12C. FIG. 12A shows that a non-electrically conductive housing 1200 may have a loop antenna 1205 surrounding the perimeter of the case and touching that perimeter. The housing may have an opening that allows inserting and removing the battery without disturbing the antenna. FIG. 12B shows a metallic case 1220 in which there is a piggybacked insulator 1222 separated from the case itself by a gap 1221. The antenna coil 1224 is formed on the insulator 1222. The magnetic field 1226 created by the antenna passes through that gap 1221, in order to escape.

FIG. 12C shows how a metallic case 1240 may also use a clamshell with a deployable loop antenna that rotates, slides or folds away from the case.

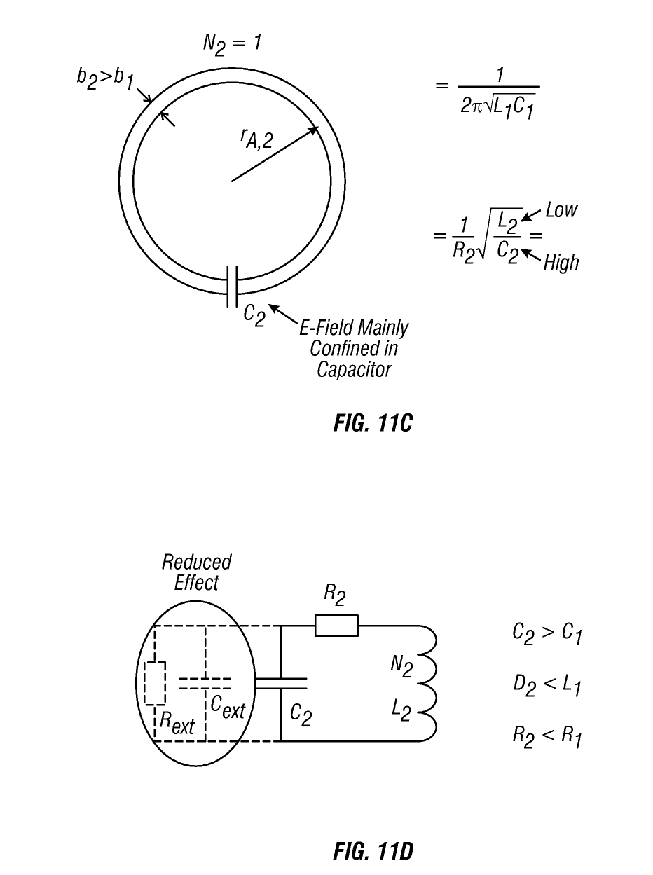

FIGS. 13A and 13B show multi-turn loop antennas integrated into a case in a way that minimizes eddy current effects. A metallic case 1300 as shown in FIG. 13A may be covered with a high permeability ferrite sheet 1305. A loop antenna 1310 can be performed directly on the ferrite sheet 1305, as shown in cross section in FIG. 13A. This may be more effective at low frequency where ferrite materials produce significant advantages.

FIG. 13B shows using a high permeability ferrite rod within the metallic case, and a coil wound around that ferrite rod. An open slot or slotted area 1360 may provide the area through which magnetic field is received.

Given a specified magnetic field strength at a specified receiver position, at an operating frequency, receive power may be expressed as:

$${P}_{r} \sim \frac{{N}^{2} {r}_{A , e}^{4}}{{R}_{tot} ( N , σ , {r}_{A} , {A}_{w} , … )}$$

where:
r_{A,e}: Equivalent antenna coil radius (For air coils: r_{A,e}=r_{A})
N: Number of turns of the wire loop antenna
Rᵣₒₜ: Resonance resistance of L-C circuit that is a function of
   r_{A}: Physical radius of the wire loop antenna
   σ: Conductivity of wire material
   A_{w}: Cross-sectional area dedicated to coil winding

Note according to this equation, that the value of N, the number of turns, appears both in the numerator and denominator, (appearing as a squared term in the numerator).

The power is also inversely proportional to A_{w}; the cross-sectional area of the winding. Increasing the cross-sectional area may improve power yield. However, this may become too heavy and bulky for practical integration.

The value δ represents the electrical conductivity of the wire material. Increasing this may increase the power yield proportional to δ^{k}, with the exponent K. in the range of 0.5 to 1. Copper and silver are the best conductors, with silver being much more expensive than copper. Room temperature superconductivity could improve this value.

R_{A} represents the physical or equivalent radius.

However, this physical radius is limited by the form factor of the device into which the antenna will be integrated. The equivalent radius of a wire loop of this type may be increased through use of materials or devices that locally increase alternating magnetic flux to generate electromotive force in the wire loop. Increasing this equivalent radius may be a very effective antenna parameter, since the received power is proportional to this radius to the fourth power. Moreover, increasing the equivalent radius also increases the Q factor by R². This produces a double benefit.

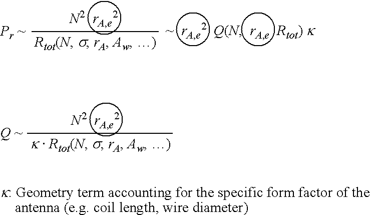

An embodiment discloses increasing the equivalent radius of a wire loop antenna without increasing its actual radius. A first technique uses materials with ferromagnetic properties such as ferrite. It is also possible to exploit the gyromagnetic effect of ferrites. In addition, the use of magneto MEMS systems can be used for this. Each of these techniques will be separately discussed.

Materials that have ferromagnetic properties (susceptibility Xₘ greater than zero) can magnify magnetic flux density inside a coil.

B=μ₀(1+Xₘ)H=μ₀(H+M)=μ₀μᵣH

where M is the magnetization of the material and uᵣ is the relative permeability of the material. The ferromagnetic material in essence adds additional magnetic flux to the already existing flux. This additional flux originates from the microscopic magnets or magnetic dipoles that are inside the material.

The magnetic dipole moment results from electron spin and orbital angular momentum in atoms. The moment mostly comes from atoms that have partially filled electron shells and unimpaired/non-compensated spins. These atoms may exhibit a useful magnetic dipole moment.

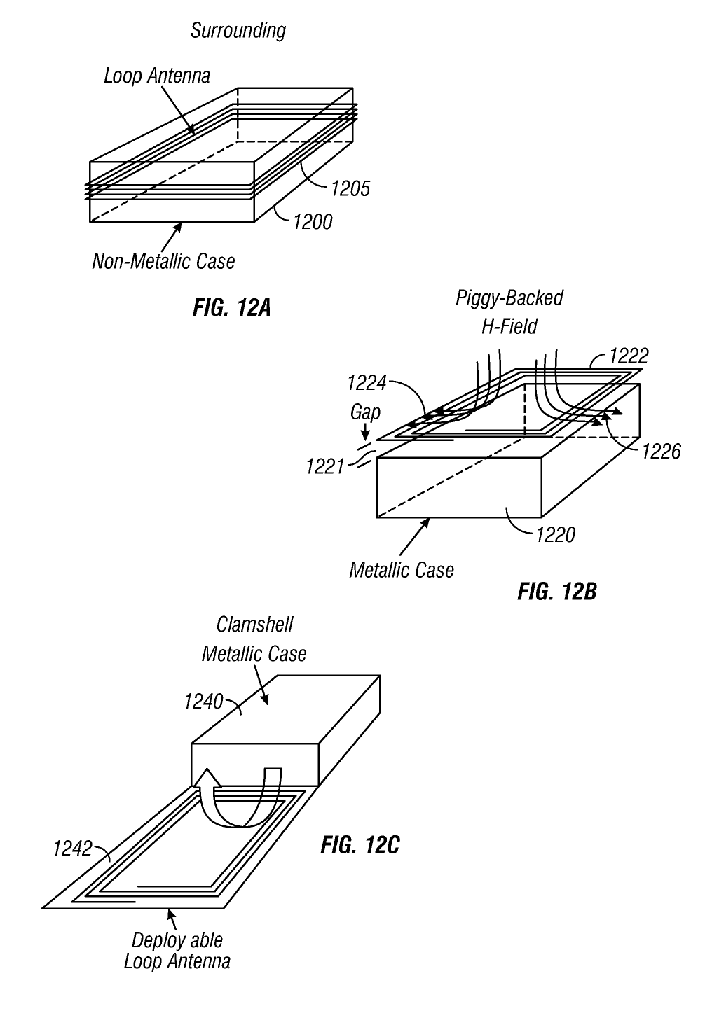

When an external magnetic field is applied, magnetic dipoles organized in lattice domains align with the external field. See FIG. 14. Higher applied magnetic fields cause more Weiss domains to be aligned with the magnetic field. Once all those domains are fully aligned, the resulting magnetic flux cannot further increase. This alignment is called saturated.

Ferrite materials typically show a hysteresis effect between the applied magnetic field or H field and the resulting B field. The B field lags behind the H field. In an induction coil wound around the ferrite rod, this effect causes a non-90 degree phase shift between the AC current and the AC voltage against the inductor. At low-H field strength, the hysteresis effect is reduced, thereby reducing losses.

The flux magnification effect of the ferrite rod depends on both the relative permeability (uᵣ) of the ferrite material used, and on the form factor of the rod, for example the diameter to length ratio. The effect of the ferrite rod and a coil antenna may be described by an equivalent relative permeability μₑ which is typically much smaller than μᵣ. For an infinite diameter and length ratio μₑ approaches μᵣ. The effect of the Ferrite rod is equivalent to an increase of antenna coil radius by \sqrt{μₑ}. At frequencies below 1 MHz and a ratio the increase of the equivalent radius by the Ferrite will be in the order of 3 to 4. Nevertheless, depending on physical size constraints, the use of a Ferrite rod may be beneficial considering that power yield increases according to r_{A,e}⁴.

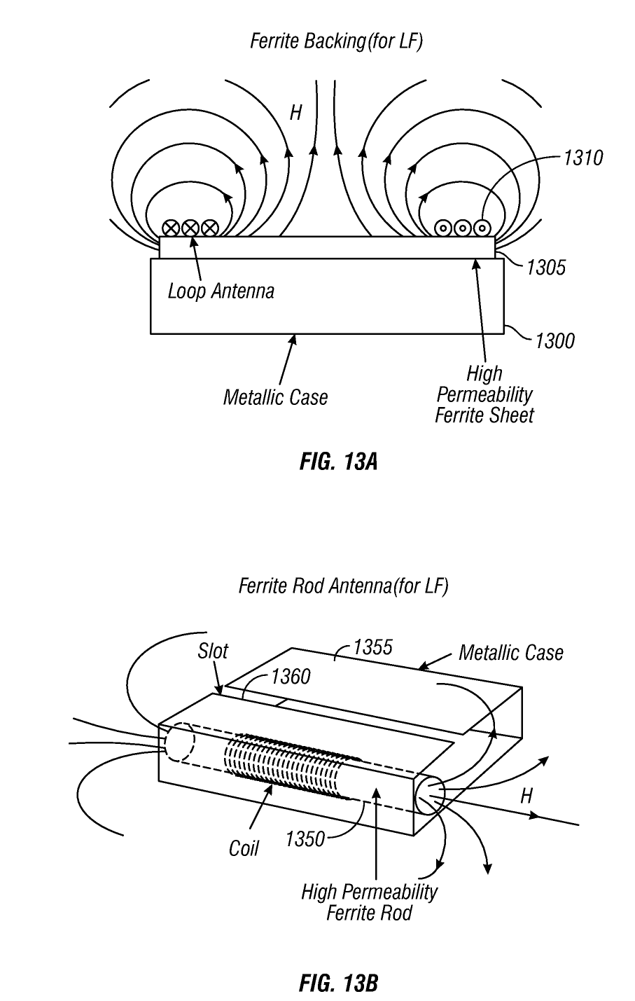

FIG. 15 illustrates how a ferrite rod can increase the physical radius R_{A} to an equivalent radius R_{A,e} which is larger than the physical radius. In essence, the use of ferrite in a wire loop antenna causes magnification of the magnetic flux by a factor μₑ which is equivalent to an increase of the coil radius by a factor of sqrt(μₑ).

The ferrite may need to be relatively long to increase the μₑ unless the coil radius is small. Ferrite antennas concentrate the magnetic flux inside the rod, which may also lower the sensitivity to the environment.

The Gyro magnetic effects of certain materials such as ferrite can also be used to increase the magnetic flux. When a static magnetic field is applied to a ferromagnetic material such that it saturates, the atomic magnetic dipole movement performs precession around the axis defined by the direction of the static magnetic field. This has an angular frequency of

ω₀=γμ₀H₀

where

with

$$γ = - \frac{m}{J}$$

the gyromagnetic ratio

m: the magnitude of the magnetic dipole moment

J: the magnitude of the angular momentum

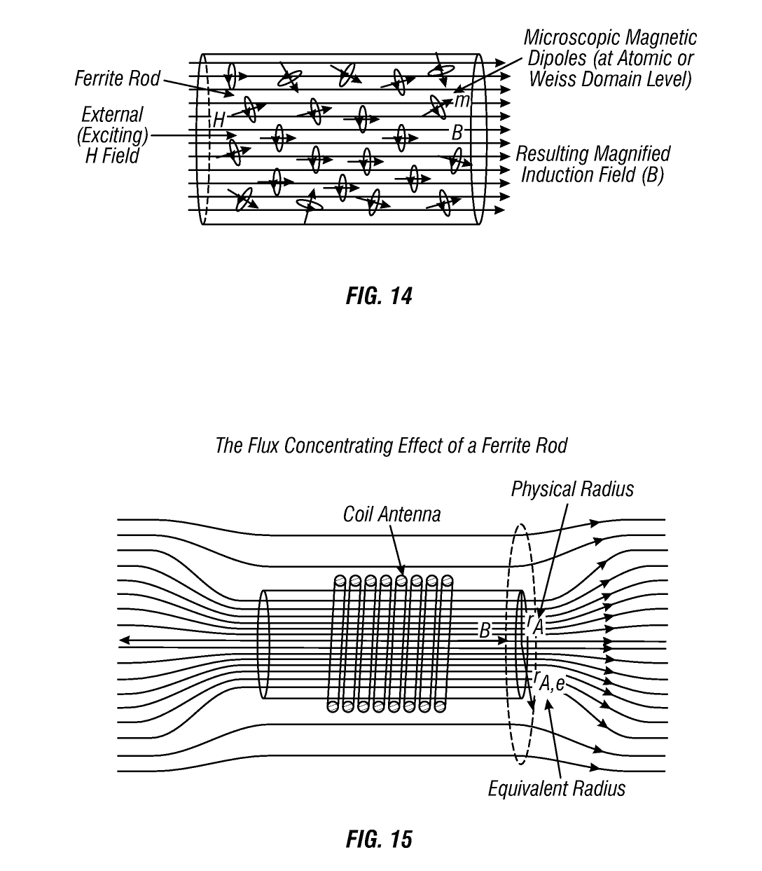

FIG. 16 illustrates the current loop and the fields. The alternating magnetic field is applied to a material can cause an electron current spin loop.

Its relative permeability can be described as a complex tensor

μᵣ=μᵣ′+jμᵣ″

which shows a resonance at ω₀. This gyromagnetic resonance effect can form resonators with very high Q factors as high as 10,000.

Properties that are similar to these Gyro magnetic materials can be reproduced with magnetomechanical systems formed using MEMS. These systems may have the potential to imitate the Gyromagnetic high Q resonance effect at lower frequency. Two different types of MEMS devices can be used: a compass type MEMS and a torsion type MEMS. The compass type MEMS uses a medium that is formed of micro-magnets that are saturated by applying a static magnetic field H0. The system exhibits resonance at the characteristic frequency defined by the magnetization and be inertial moment of the micro-magnets.

Similarly, a torsion type MEMS is formed of micro-magnets that can move along a torsion beam. The system exhibits ferromagnetic resonance based on the magnetization and inertial moment as well as the spring constant.

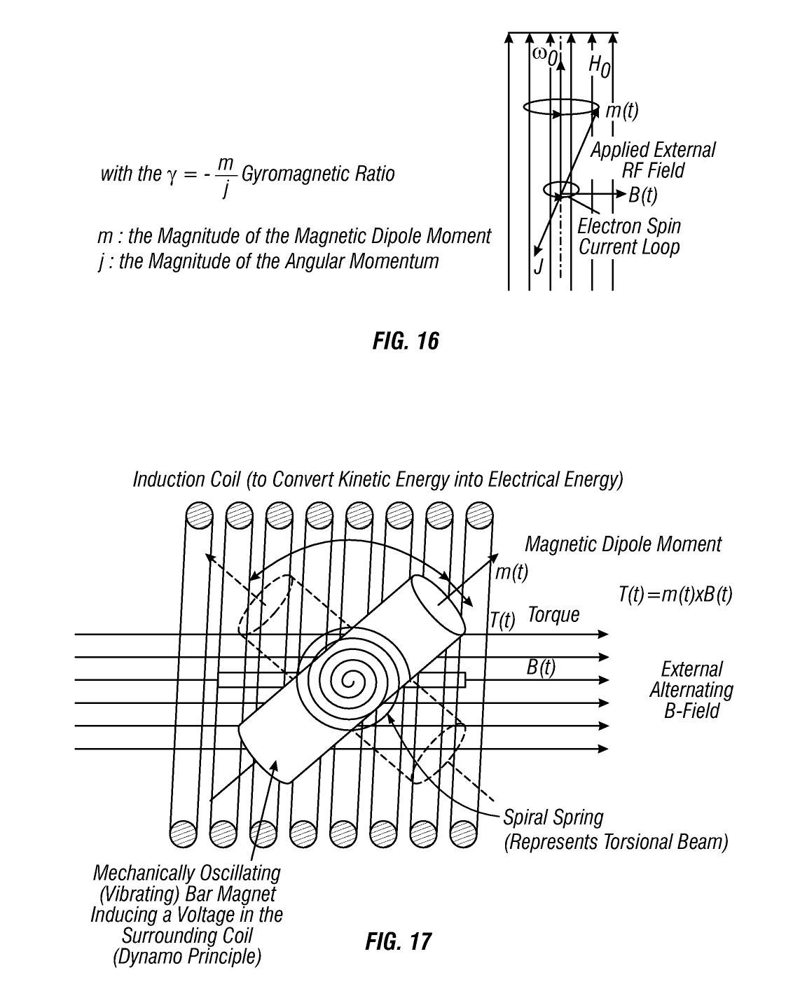

FIG. 17 illustrates the basic principle of a torsion type Magneto-Mechanical System. In the context of power transmission, these mems devices may operate as a ferrite that amplifies the magnetic flux, a high Q. resonator, and/or a dynamo that is remotely driven by the transmitter. The dynamo receiver might convert electric energy to magnetic energy to kinetic energy back to electric energy at a remote location.

While the drawing shows mechano magneto oscillators that are bar-shaped, an embodiment may use disk or sphere shaped materials to improve their movability.

Another possible way of transforming magnetic energy into electrical energy is combined magnetoscriction and piezoelectricity, which can be thought of as reverse electrostriction. Magnetostriction is the changing of the material shape when the material is subjected to a magnetic field. This shape change can occur when the boundaries of Weiss domains within a material migrate or when the domains rotate through external field. Cobalt and Terfenol-D have very high magnetostrictions. The relation between the strain and applied magnetic field strength becomes nonlinear.

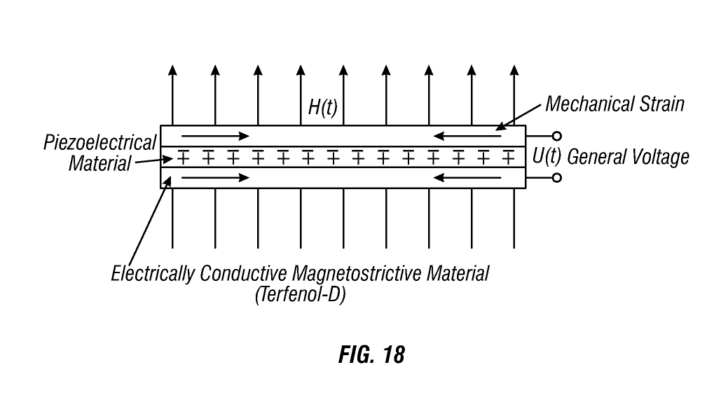

A ribbon of magnetostrictive material with a length of a few centimeters shows a resonance that is similar to piezo crystals and quartz in the low-frequency range e.g. around 100 kHz. This effect is also used in passive RFID systems to cause a resonance that can be detected by the RFID coil. FIG. 18 shows using a magnetostrictive and piezoelectric material to generate electrical power from a low magnetic field.

Although only a few embodiments have been disclosed in detail above, other embodiments are possible and the inventors intend these to be encompassed within this specification. The specification describes specific examples to accomplish˜more general goal that may be accomplished in another way. This disclosure is intended to be exemplary, and the claims are intended to cover any modification or alternative which might be predictable to a person having ordinary skill in the art. For example, other sizes, materials and connections can be used. Although the coupling part of the antenna in some embodiments is shown as a single loop of wire, it should be understood that this coupling part can have multiple wire loops. Other embodiments may use similar principles of the embodiments and are equally applicable to primarily electrostatic and/or electrodynamic field coupling as well. In general, an electric field can be used in place of the magnetic field, as the primary coupling mechanism. While MEMS is described in embodiments, more generally, any structure that can create small features could be used.

Any of the embodiments disclosed herein are usable with any other embodiment. For example, the antenna formation embodiments of FIGS. 12A-12C can be used with the flux magnification embodiments.

Also, the inventors intend that only those claims which use the-words “means for” are intended to be interpreted under USC 112, sixth paragraph. Moreover, no limitations from the specification are intended to be read into any claims, unless those limitations are expressly included in the claims.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

What is claimed is:

1. An system for receiving magnetic transmission of power, comprising:
a wire loop antenna, having a wire formed into at least one loop forming an inductance, and having a capacitance, said wire loop antenna having an LC value tuned for receiving a magnetic field of a first specified frequency, and producing an output based on receiving said magnetic field that includes electrical power; and
said antenna including a first electrical part associated with said wire loop antenna which increases an equivalent radius of the wire loop portion of said antenna without increasing an actual radius of a wire loop antenna.

2. A system as in claim 1, wherein said wire loop is a rectangular loop.

3. A system as in claim 2, wherein said rectangular loop has rounded edges.

4. An antenna system as in claim 1, wherein said first electrical part causes a magnetic field to be created as though said wire loop had an equivalent radius, greater than its physical radius.

5. An antenna system as in claim 1, wherein said first electrical part includes a part formed of a ferrite material.

6. An antenna system as in claim 1, wherein said first electrical part includes a part formed of a material that adds additional magnetic flux to an already existing flux.

7. An antenna system as in claim 1, wherein said first electrical part is a flux magnification part.

8. An antenna system as in claim 7, wherein said flux magnification part has a relative permeability, and the flux magnification is increased by the square root of the relative permeability.

9. An antenna system as in claim 7, wherein said flux magnification part includes a rod, and an amount of flux magnification is related to a length of said rod.

10. A system as in claim 1, further comprising a housing, adapted for housing mobile electronics, and wherein said wire loop antenna is oriented to surround at least one area of said housing.

11. A system as in claim 1, further comprising a connection to a wireless power circuit, carrying said output.

12. The system as in claim 10, wherein said wire loop antenna surrounds a complete outer perimeter of said housing.

13. A system as in claim 10, wherein said housing is formed of a metallic material, and said antenna is separated from said metallic material.

14. A system as in claim 13, wherein said separation forms a gap, of a size through which magnetic fields can escape.

15. A system as in claim 13, wherein said loop antenna is separable from said housing and movable relative thereto.

16. A system as in claim 13, further comprising a ferrite portion, coupled to said housing, and holding at least a part of said antenna separated from said housing.

17. A system as in claim 9, further comprising a housing, adapted for housing mobile electronics, and said rod is within said housing, wherein said wire loop antenna is wound around said rod.

18. A system as in claim 1, further comprising at least one opening in said housing, allowing magnetic fields to pass through said opening and to interact with said rod.

19. A system as in claim 18, wherein said Rod is formed of a ferrite material.

20. A system as in claim 17, further comprising a slot in said housing.

21. A system as in claim 20, wherein said housing is formed of a conductive material.

22. A method for receiving a magnetic transmission of power, comprising:
using a resonator with an LC ratio formed by a wire loop antenna tuned to a value that is resonant with a frequency of a magnetic field, said resonator having a wire loop forming an inductance, and having a capacitance;
said using comprising increasing an equivalent radius of the wire loop portion of said antenna without increasing an actual radius of a wire loop antenna;
receiving said magnetic field and producing usable power based thereon;
applying said power to a load, to power said load based on receiving said magnetic field that includes electrical power.

23. A method as in claim 22, wherein said wire loop is a rectangular loop.

24. A method as in claim 23, wherein said rectangular loop has rounded edges.

25. A method as in claim 23, wherein said increasing comprises adding additional magnetic flux to an already existing flux.

26. A method as in claim 23, further comprising magnifying a flux created by said resonator.

27. A method as in claim 23, further comprising a housing, adapted for housing mobile electronics, and further comprising using said wire loop antenna which is oriented to surround at least one area of said housing.

28. The method as in claim 27, wherein said wire loop antenna surrounds a complete outer perimeter of said housing.

29. A method as in claim 27, wherein said housing is formed of a metallic material, and further comprising using said wire loop antenna which is separated from said metallic material.

30. A method as in claim 29, further comprising using a gap between said wire loop antenna and said metallic material, to receive magnetic fields can escape.

31. A method as in claim 22, wherein said loop antenna is separable from said housing and further comprising allowing moving said loop antenna movable relative to said housing.

32. An antenna system for magnetic power transfer, comprising:
a resonator formed of an inductive loop and a capacitor element; and
a first compensating structure, which compensates for effects of extraneous objects on the resonator.

33. A system as in claim 32, wherein said antenna has a Q factor of greater than 1500.

34. In the antenna as in claim 32, wherein said antenna system has a Q factor of greater than 2000.

35. A system as in claim 34, wherein said antenna is a single loop antenna.

36. A system as in claim 32, wherein said inductive loop has a rectangular shape.

37. A method, comprising:
determining if an environment will have dielectric losses or Eddy current losses;
selecting a resonator with high inductance to capacitance ratio resonator for an environment where eddy current losses are predominant, based on said determining;
selecting a low inductance to capacitance ratio resonator for an environment where dielectric losses are predominant, based on said determining; and
using said selected resonator as part of a system to retrieve electrical power from a magnetic power transmission.

38. A method as in claim 37, wherein said low inductance to capacitance ratio antenna has more than 2 turns of an inductive loop.

39. A method as in claim 37, wherein said high inductance to capacitance ratio antenna has two or fewer turns of an inductive loop.

40. A method as in claim 37, wherein said antenna has a Q greater than 1500.

41. A system for receiving wireless power, comprising:
a housing, adapted for housing mobile electronics;
a loop antenna portion, oriented to surround at least one area of said housing; and
a connection to a wireless power circuit.

42. The system as in claim 41, wherein at least one portion of said antenna surrounds a complete outer perimeter of said housing.

43. A system as in claim 42, wherein said housing is formed of a nonmetallic material, and said antenna is physically in contact with said nonmetallic material.

44. A system as in claim 41, wherein said housing is formed of a metallic material, and said antenna is separated from said metallic material.

45. A system as in claim 44, wherein said separation forms a gap, of a size through which magnetic currents can escape.

46. A system as in claim 41, wherein said loop antenna is separable from said housing and movable relative therewith.

47. A system as in claim 41, further comprising a ferrite portion, coupled to said housing, and holding at least a part of said antenna.

48. A system for receiving wireless power, comprising:
a housing, adapted for housing mobile electronics;
a coil winding form, extending across said housing from at least a first side of said housing to a second side of said housing;
a coil, wound around said form; and
at least one opening and said housing, allowing magnetic fields to interact with said form.

49. A system as in claim 48, wherein said form is formed of a ferrite material.

50. A system as in claim 48, further comprising a slot in said housing.

51. A system as in claim 48, wherein said housing is formed of a conductive material.

52. A system as in claim 48, wherein said form is a cylindrical shaped form.

53. A system, comprising:
a first layer of a first material which converts mechanical strain to electrical energy;
a second layer, in mechanical contact with said first layer, and formed of a second material which is sensitive to, and caused to change in position by, an applied magnetic field;
an output terminal, connected to receive said electrical energy from said first layer.

54. The system as in claim 53, wherein said second layer is an electrically conductive magnetostrictive material.

55. The system as in claim 53, wherein said first layer is a piezoelectric material.

56. A system as in claim 53, wherein said output terminal is connected directly to said second layer.

57. A system as in claim 56, wherein there is a third layer formed of said first material, and said second layer is sandwiched between said first layer and said third layer, said first material is electrically conductive, and said output terminals are connected between said first and third layers of said first material.

58. A system as in claim 57, wherein said first material is arranged such that a varying magnetic field compresses said second part.
